(19) United States
(12) Patent Application Publication
(10) Pub. No.: US 2013/0335188 A1
(43) Pub. Date: Dec. 19, 2013

(54) Safety Fuse Arrangement

(71) Applicant: Siemens Aktiengesellschaft, Munchen (DE)

(72) Inventors: Markus Faltermeier, Regensburg (DE); Robert Huettinger, Schoefweg (DE); Thomas Lohr, Sinzing (DE); Adolf Schmid, Laaber (DE)

(21) Appl. No.: 13/921,925

(22) Filed: Jun. 19, 2013

(30) Foreign Application Priority Data
Jun. 19, 2012 (DE) 10 2012 210 292.2

(51) Int. Cl. H01H 85/02

(52) U.S. Cl. CPC H01H 85/02
USPC 337/283

(57) ABSTRACT

A safety fuse arrangement may include at least a first safety fuse element and a second safety fuse element electrically connected to each other in parallel. The safety fuse arrangement further comprises a ceramic fuse body having at least a first locating space for locating and holding the first safety fuse element and a second locating space for locating and holding the second safety fuse element. The locating spaces are physically separated from each other by the fuse body. In this way, a compact safety fuse arrangement comprising a plurality of safety fuse elements which are electrically connected to each other in parallel can be realized as a structural unit that is inexpensive to manufacture and is suitable for higher rated currents.

### CROSS-REFERENCE TO RELATED APPLICATIONS

This application claims priority to DE Patent Application No. 10 2012 210 292.2 filed Jun. 19, 2012. The contents of which is incorporated herein by reference in its entirety.

### TECHNICAL FIELD

This disclosure relates to a safety fuse arrangement in which a plurality of safety fuse elements are electrically connected to each other in parallel.

### BACKGROUND

Electrical conductors heat up when an electric current flows through them. Excessive currents can cause excessive heating of the electrical conductor in this case, such that melting of the insulation and possibly even a cable fire can occur. In order to prevent this fire hazard, provision must be made for a timely cutoff in the event of an electrical current that is too high, e.g. an overload current or short-circuit current. This cutoff is achieved by means of an overload protection device.

These overload protection devices include safety fuses, for example. A safety fuse has a fuse element comprising at least one fusible conductor which has a relatively small cross section. In the event of an overload current, i.e. if the current intensity exceeds a specific value for longer than a specific time duration, the fusible conductor is melted and the current flow thereby interrupted. The safety fuse consists essentially of an insulating body which has two electrical terminals, these being connected together by means of the fusible conductor inside the insulating body. The fusible conductor is heated by the electric current flowing through it, and melts if the applicable rated current of the safety fuse is clearly exceeded for a specific time. Ceramics are generally used as a material for the insulating body due to their good insulating properties. Such a safety fuse element is disclosed in the European patent document EP 0 917 723 B1.

There is a growing demand for safety fuses having higher rated currents. However, this can only be achieved with difficulty and at disproportionately high cost using the fuse sizes that are currently available. One way of achieving the required higher rated currents is nonetheless to arrange a plurality of safety fuses such that they are connected in parallel electrically. Such safety fuses are used inter alia in so-called electrical installation distribution frames in the field of electrical installations. Since the structural space in a distribution frame of an electrical installation is usually limited, provision is made in existing electrical installations for the electrical line requiring protection to be divided into a plurality of lines which are electrically connected to each other in parallel, and which are protected by a dedicated safety fuse in each case. The maximal current intensity per safety fuse is reduced correspondingly in this case, such that thinner and flatter fuse bodies can be used. It is thus possible to realize an arrangement that is as compact as possible. Furthermore, the dissipated power and the I²t value also decrease as a result of the safety fuses being connected in parallel.

It is however problematic in this type of configuration that in the event of a fuse replacement, the safety fuses can be removed and exchanged individually from a group of safety fuses that are electrically connected to each other in parallel, and this presents problems in respect of the approval of such connections for specific applications. For it could occur in this case that although a damaged safety fuse is replaced, the other safety fuses, which might have been previously damaged, nonetheless remain in the group. Furthermore, a safety fuse might be removed from the group and replaced by a safety fuse of a different type (of corresponding identical size). In the context of stricter approval procedures, it is essential to prevent these possibilities.

### SUMMARY

One embodiment provides a safety fuse arrangement, comprising: at least a first safety fuse element and a second safety fuse element, these being electrically connected to each other in parallel, and a ceramic fuse body which features at least a first locating space for locating and holding the first safety fuse element and a second locating space for locating and holding the second safety fuse element, wherein the locating spaces are physically separated from each other by the fuse body.

In a further embodiment, the safety fuse arrangement comprises at least one further safety fuse element which is located and held in at least one further locating space of the ceramic fuse body.

In a further embodiment, the ceramic fuse body has the shape of a prism or a cylinder having a direction of longitudinal extension, and can be produced in the direction of longitudinal extension by means of extrusion.

In a further embodiment, the safety fuse arrangement has at least two cover plates for securely sealing the locating spaces, said cover plates being tightly but removably attached to the fuse body.

In a further embodiment, the cover plates are so designed as to provide an electrical contacting means of the safety fuse elements.

In a further embodiment, at least one of the cover plates is so designed that it can be coupled to a further fuse body.

In a further embodiment, each of the safety fuse elements is assigned a dedicated first contact and a dedicated second contact, these projecting from the fuse body which is sealed by the cover plates.

In a further embodiment, the first contacts and/or the second contacts are designed as blade contacts.

In a further embodiment, at least one of the blade contacts is so designed as to be slotted.

### BRIEF DESCRIPTION OF THE DRAWINGS

Example embodiments of the fuse arrangement are explained in greater detail below with reference to the drawings, in which:

FIGS. 1A to 1C show schematic illustrations of a first exemplary embodiment of the safety fuse arrangement; and

FIGS. 2A to 2D show schematic illustrations of a second exemplary embodiment of the safety fuse arrangement.

### DETAILED DESCRIPTION

Embodiments of the present invention provide an alternative fuse arrangement, which may overcome the problem cited in the background section.

One embodiment provides a safety fuse arrangement comprising at least a first safety fuse element and a second safety fuse element. The first and the second safety fuse elements are electrically connected to each other in parallel in this case. The safety fuse arrangement further comprises a ceramic fuse body which features at least a first locating space for locating and holding the first safety fuse element, and a second locating space for locating and holding the second safety fuse element. The locating spaces are physically separated from each other by the fuse body in this case.

By virtue of using a single shared ceramic body featuring locating spaces for a plurality of safety fuse elements, it is possible to arrange a plurality of fusible conductor modules, i.e. a plurality of safety fuse elements, such that they are electrically parallel to each other. Each locating space is assigned exactly one safety fuse element in this case. This fuse arrangement based on a parallel connection makes it possible to meet the demand for rated currents that are correspondingly higher. Moreover, this fuse arrangement represents an inseparable unit—a requirement that must be satisfied in relation to approval for specific applications.

A further advantage relates to the ceramic fuse body forming the housing of the safety fuse arrangement. If a plurality of individual safety fuses are connected in parallel, the individual fuse bodies must have the same size and length in order that they can be connected to form a structural unit. Since tolerances apply in respect of the dimensional accuracy of the components for reasons relating to production engineering in the case of ceramic components, the individual fuse bodies must be ground down in a further production stage in order to achieve exactly the length that is required to form a structural unit. This further production stage is both resource-intensive and expensive, and can be avoided by using a single shared fuse body for a plurality of fuse elements that are electrically connected in parallel.

In one embodiment, the safety fuse arrangement features at least one further safety fuse element which is located and held in at least one further locating space of the ceramic fuse body. Instead of two safety fuse elements, it is obviously also possible to arrange more safety fuse elements that are electrically connected in parallel in a shared fuse body which comprises a number of locating spaces corresponding to the number of safety fuse elements.

In a further embodiment of the safety fuse arrangement, the ceramic fuse body has the shape of a prism or cylinder having a direction of longitudinal extension (L), and can be produced in a direction of longitudinal extension (L) by means of extrusion.

In geometrical terms, extrusion refers to a dimensional increase of an element by means of a parallel shift in space. Extrusion of a surface produces a body which is delimited by two parallel plane surfaces (the base and the top surface) and a jacket or cylindrical surface formed of parallel straight lines. This body is a (geometrical) cylinder in the general sense. If a circle forms the base surface, this produces the specific case of a circular cylinder. If the base surface represents a polygon, a prism is produced as a result of the extrusion. In the field of production engineering, the term ‘extrusion’ refers to a manufacturing process in which a solid to semi-fluid setting mass is continuously forced out of a shaping outlet under pressure, said shaping outlet being also referred to as a nozzle, matrix or die relief. This produces (cylindrical) bodies having the cross section of the outlet and theoretically unlimited length (in the direction of longitudinal extension). An essential advantage of the extrusion process is that brittle and/or soft materials including ceramics can also be processed efficiently at comparatively low manufacturing cost.

In a further embodiment, the safety fuse arrangement features at least two cover plates for securely sealing the locating spaces. The cover plates are tightly but removably attached to the fuse body in this case. The locating spaces can be securely sealed by virtue of the cover plates. Provision can be made for individual cover plates, each of which is assigned to one of the locating spaces, or for two shared cover plates for all of the locating spaces, said cover plates being attached to both sides of the ceramic fuse body in the direction of longitudinal extension in order to seal the locating spaces securely.

In a further embodiment of the safety fuse arrangement, the cover plates are so designed as to provide an electrical contacting means of the safety fuse elements. In this way, the electrical parallel connection of the safety fuse elements is provided by the cover plates that are already present. An additional contacting element is therefore no longer necessary, thereby reducing the number of parts. The assembly expense and the logistical costs are consequently reduced.

In a further embodiment of the safety fuse arrangement, at least one of the cover plates is designed such that it can be coupled to a further fuse body. In this way, a plurality of fuse bodies can be arranged in series in the direction of longitudinal extension. In this case, two adjacent fuse bodies are mechanically and/or electrically coupled together by a cover plate that is arranged between them. So-called presspack applications can also be realized in this way.

In a further embodiment of the safety fuse arrangement, each of the safety fuse elements is assigned a dedicated first contact and a dedicated second contact, said contacts projecting from the fuse body that is sealed by the cover plates. The first contacts and the second contacts are connected in an electrically conductive manner to one of the safety fuse elements in each case and project from the sealed fuse body in the direction of longitudinal extension. They are used as the individual electrical contacting means of the respective safety fuse element.

In a further embodiment of the safety fuse arrangement, the first contacts and/or the second contacts are designed as slotted blade contacts. Blade contacts are also known as contact blades and are suitable for conducting higher currents due to their correspondingly solid construction.

In a further embodiment of the safety fuse arrangement, at least one of the blade contacts is so designed as to be slotted. Slotted contacts allow quick and simple fastening and contacting of the safety fuse arrangement, e.g., to a conductor rail.

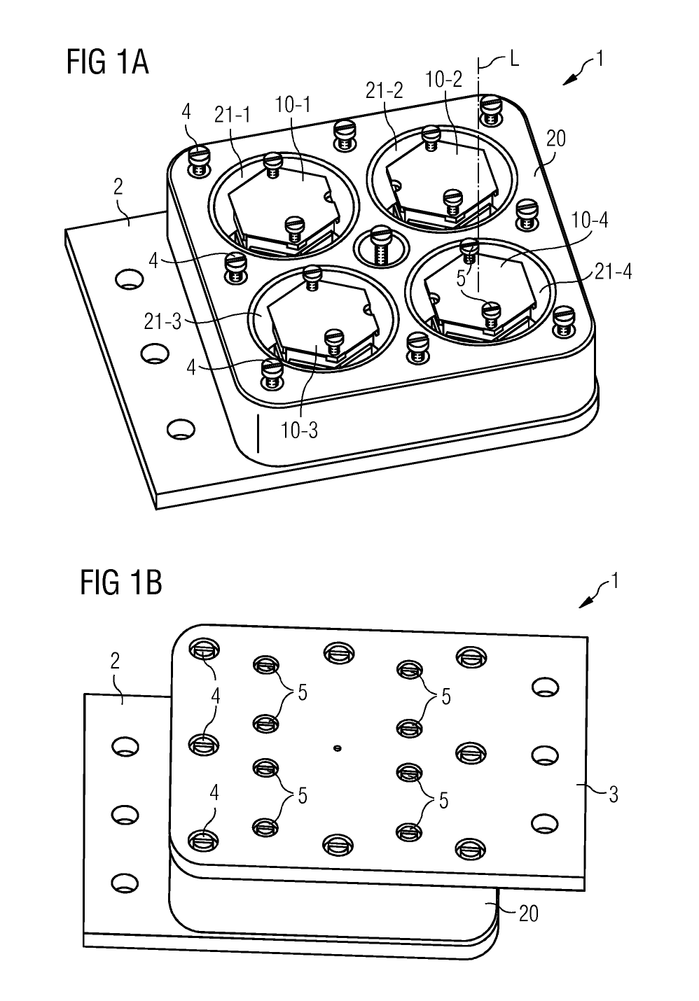

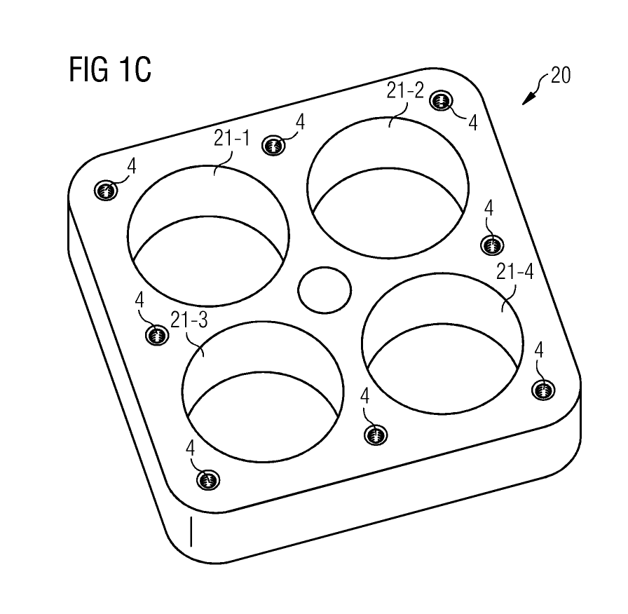

The FIGS. 1A to 1C schematically illustrate a first exemplary embodiment of the fuse arrangement 1. The fuse arrangement 1 has a ceramic fuse body 20 with four locating spaces 21-1, 21-2, 21-3, 21-4, these being arranged on a plane which is so oriented as to be parallel with an end face of the fuse body 20. The fuse body 20 has the shape of a geometrical cylinder in the general sense, the end faces forming the base surface and the top surface of the cylinder. By virtue of this shape, the fuse body 20 can be manufactured from ceramic material by means of extrusion. One safety fuse element 10-1, 10-2, 10-3, 10-4 is arranged in each of the locating spaces 21-1, 21-2, 21-3, 21-4. The hollow spaces that remain after arranging the safety fuse elements 10-1, 10-2, 10-3, 10-4 in the locating spaces 21-1, 21-2, 21-3, 21-4 are then filled with a suitable filler material, e.g. compacted quartz sand.

The fuse arrangement 1 also features a lower cover plate 2 and an upper cover plate 3, these being tightly but removably attached to the fuse body 20 by means of a plurality of screw connections 4 and providing a secure external seal for the locating spaces 21-1, 21-2, 21-3, 21-4 of the fuse body 20. The safety fuse elements 10-1, 10-2, 10-3, 10-4 feature further screw connections 5, by means of which they can be fastened to one of the cover plates 2, 3. These further screw connections 5 can also be used to realize an electrical contact of the respective safety fuse element 10-1, 10-2, 10-3, 10-4.

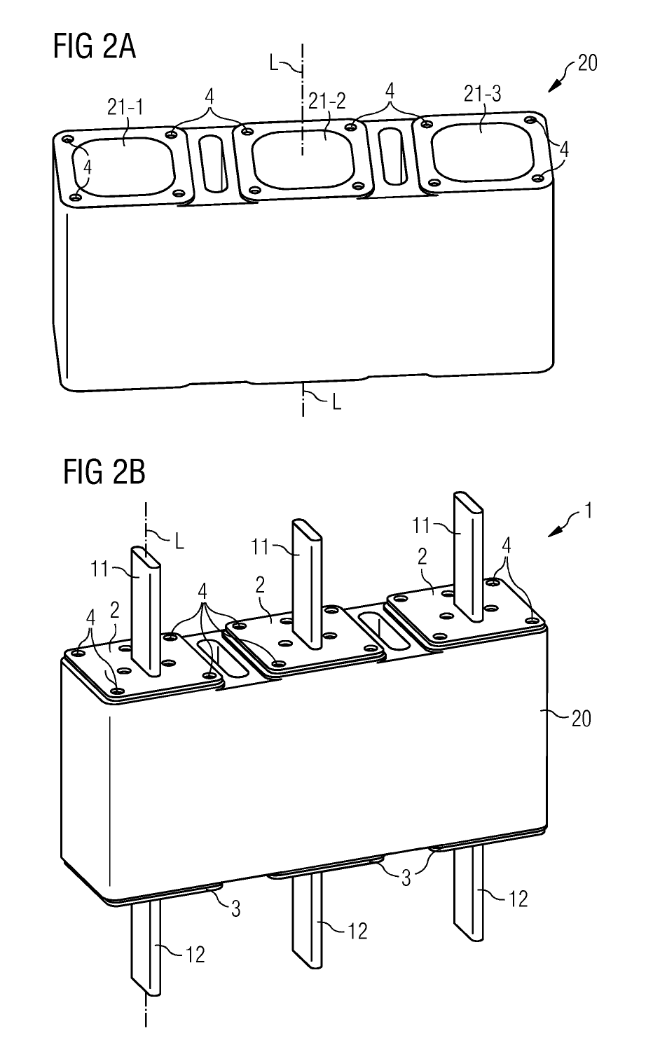

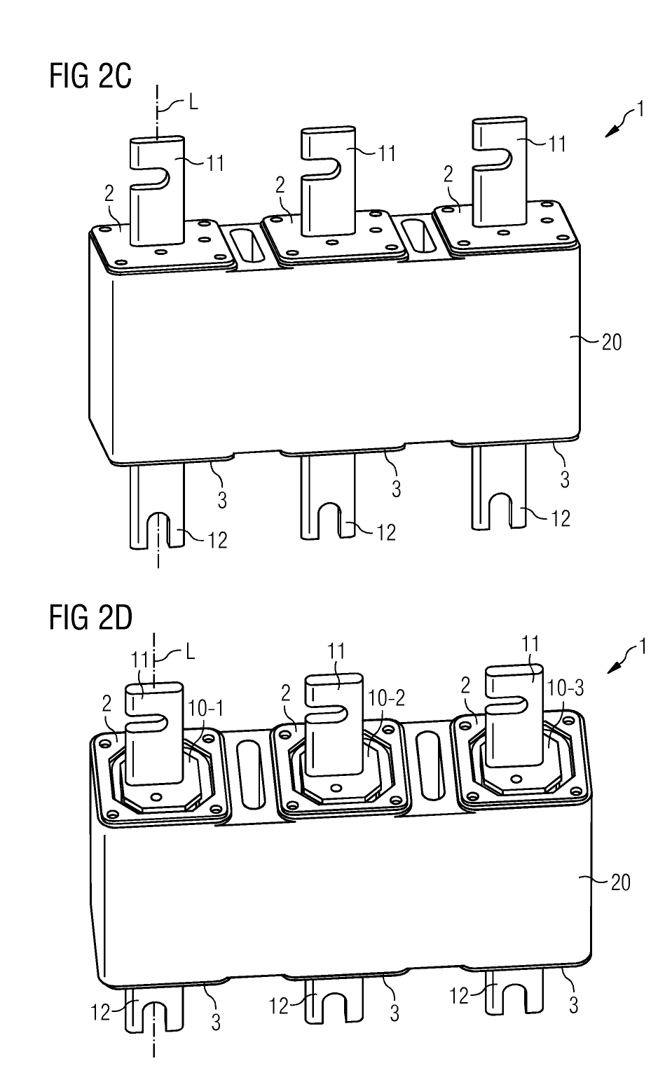

The FIGS. 2A to 2D schematically illustrate a second exemplary embodiment of the fuse arrangement 1. This safety fuse arrangement 1 likewise features a ceramic fuse body 20 with three locating spaces 21-1, 21-2, 21-3, these being arranged adjacently to each other. The shape of the fuse body 20 is again suitable for extrusion from a ceramic material in this case. At its two end faces, the fuse body 20 features a plurality of threaded holes for screw connections 4, by means of which the cover plates 4, 5 can be tightly but removably attached to the fuse body 20. One safety fuse element 10-1, 10-2, 10-3 in each case is arranged in each of the locating spaces 21-1, 21-2, 21-3. Each of the safety fuse elements 10-1, 10-2, 10-3 is again assigned a first contact 11 and a second contact 12, these being designed as solid blade contacts in this exemplary embodiment. As shown in the FIGS. 2C and 2D, the blade contacts can also be of a slotted design in this case, in order to allow quick and simple fastening and contacting of the safety fuse arrangement 1. The individual safety fuse elements 10-1, 10-2, 10-3 can also be electrically interconnected by means of shared cover plates and contacted jointly.

By virtue of using a shared fuse body 20 comprising a plurality of locating spaces 21-1, 21-2, 21-3, 21-4 for a plurality of safety fuse elements 10-1, 10-2, 10-3, 10-4 which are electrically connected to each other in parallel, it is possible to avoid the production engineering problems that occur in relation to the length tolerances of the individual fuse bodies 20 which are connected together to form a structural unit in the context of a conventional parallel connection of a plurality of individual safety fuses. An extremely compact solution for parallel-connected safety fuses can also be realized thus.

### LIST OF REFERENCE SIGNS

1 Fuse arrangement

2 Cover plate

3 Cover plate

4 Screw connection

5 Further screw connection

10-1 First safety fuse element

10-2 Second safety fuse element

10-3 Further safety fuse element

10-4 Further safety fuse element

11 First contact

12 Second contact

20 Fuse body

21-1 First locating space

21-2 Second locating space

21-3 Further locating space

21-4 Further locating space

L Direction of longitudinal extension

What is claimed is:

1. A safety fuse arrangement, comprising:
a first safety fuse element and a second safety fuse element electrically connected to each other in parallel, and
a ceramic fuse body comprising a first locating space for locating and holding the first safety fuse element and a second locating space for locating and holding the second safety fuse element,
wherein the first and second locating spaces are physically separated from each other by the fuse body.

2. The safety fuse arrangement of claim 1, comprising at least one further safety fuse element located and held in at least one further locating space of the ceramic fuse body.

3. The safety fuse arrangement of claim 1, wherein the ceramic fuse body has a prism or cylinder shape having a direction of longitudinal extension, and is formed by extrusion in the direction of longitudinal extension.

4. The safety fuse arrangement of claim 1, comprising at least two cover plates for securely sealing the locating spaces, the cover plates being tightly but removably attached to the fuse body.

5. The safety fuse arrangement of claim 3, wherein the cover plates provide an electrical contacting structure for the safety fuse elements.

6. The safety fuse arrangement of claim 4, wherein at least one of the cover plates is configured to be coupled to a further fuse body.

7. The safety fuse arrangement of claim 4, wherein each safety fuse element is assigned a dedicated first contact and a dedicated second contact projecting from the fuse body which is sealed by the cover plates.

8. The safety fuse arrangement of claim 7, wherein at least one of the first and second contacts is configured as a blade contact.

9. The safety fuse arrangement of claim 8, wherein at least one of the blade contacts is slotted.

10. The safety fuse arrangement of claim 1, comprising a cover plate removably attached to the fuse body and covering both the first and second locating spaces.

11. The safety fuse arrangement of claim 1, comprising a first cover plate removably attached to a first side of the fuse body and covering both the first and second locating spaces, and
a second cover plate removably attached to a second side of the fuse body and covering both the first and second locating spaces.

12. The safety fuse arrangement of claim 1, comprising a plurality of cover plates removably attached to the fuse body, each cover plate covering exactly one of the locating spaces.

13. A safety fuse apparatus, comprising:
a ceramic fuse body comprising multiple locating spaces configured to locate and hold multiple safety fuse elements electrically connected in parallel,
wherein the first and second locating spaces are physically separated from each other by the fuse body.

14. The safety fuse apparatus of claim 13, wherein the ceramic fuse body comprises at least three locating spaces configured to locate and hold at least three safety fuse elements.

15. The safety fuse apparatus of claim 13, wherein the ceramic fuse body has a prism or cylinder shape having a direction of longitudinal extension, and is formed by extrusion in the direction of longitudinal extension.

16. The safety fuse apparatus of claim 13, comprising at least two cover plates removably attached to the fuse body to securely seal the locating spaces.

17. The safety fuse apparatus of claim 16, wherein the cover plates provide an electrical contacting structure for safety fuse elements received in the locating spaces.

18. The safety fuse apparatus of claim 13, wherein the ceramic fuse body has a plurality of blade contacts projecting from the fuse body.

19. The safety fuse apparatus of claim 18, wherein at least one of the blade contacts is slotted.
